(19) United States
(12) Patent Application Publication
(10) Pub. No.: US 2016/0344925 A1
(43) Pub. Date: Nov. 24, 2016

(54) ELECTRONIC DEVICE AND METHOD OF OPERATING CAMERA OF THE SAME

(71) Applicant: Samsung Electronics Co., Ltd., Gyeonggi-do (KR)

(72) Inventor: Seoghee JEONG, Gyeonggi-do (KR)

(21) Appl. No.: 15/149,355

(22) Filed: May 9, 2016

(30) Foreign Application Priority Data
May 18, 2015 (KR) 10-2015-0068815

(51) Int. Cl. H04N 5/232; G01P 15/00; H04B 1/3827

(52) U.S. Cl. CPC H04N 5/23216; H04B 1/3827; H04N 5/23241; G01P 15/00

(57) ABSTRACT

An electronic device comprising: at least one camera; an accelerometer; a memory; and at least one processor operatively coupled to the memory, configured to: detect a movement of the electronic device by using the accelerometer; and perform an operation associated with the at least one camera based on the movement.

### CLAIM OF PRIORITY

This application claims priority under 35 U.S.C. §119(a) to Korean Patent Application Serial No. 10-2015-0068815, which was filed in the Korean Intellectual Property Office on May 18, 2015, the entire disclosure of which is incorporated herein by reference.

### BACKGROUND

1. Field of the Invention

The present disclosure relates to electronic devices, in general, and more particularly to an electronic device and method of operating camera of the same.

2. Description of Related Art

Accelerometers (acceleration sensors) refer to devices that are capable of measuring acceleration of an object, caused by dynamic forces, such as vibration, impact, etc., by processing the output signals. Accelerometers are capable of sensing motion states of an object. Accelerometers have a variety of application fields and are used in various ways. A 3-axis accelerometer refers to a device for simultaneously measuring accelerations in the x-, y-, and z-axes. That is, the 3-axis accelerometer measures the rate of change of velocity in each axis. The measured acceleration is the rate of change of the velocity per unit time, or the rate at which an object changes its velocity per unit time. Accelerometers convert the movement measurement of a moving object, such as a velocity, an acceleration, etc., into an electrical value (e.g., a voltage), thereby obtaining a numerical value corresponding to the acceleration or velocity.

When a user of an electronic device takes a selfie using a camera located on the front of the electronic device (front camera), he/she needs to touch a user interface (UI) shutter button on the front display or press a shutter button on the side, which makes his/her pose unstable or steady. This causes user inconvenience.

### SUMMARY

According to aspects of the disclosure, an electronic device is provided comprising: at least one camera; an accelerometer; a memory; and at least one to processor operatively coupled to the memory, configured to: detect a movement of the electronic device by using the accelerometer; and perform an operation associated with the at least one camera based on the movement.

According to aspects of the disclosure, a method is provided for use in an electronic device, comprising: detecting a movement of the electronic device by using an accelerometer; and performing an operation associated with at least one camera based on the movement.

According to aspects of the disclosure, a non-transitory computer-readable medium is provided that stores one or more processor-executable instructions, which when executed by an electronic device cause the electronic device to perform a method comprising the steps of: detecting a movement of the electronic device by using an accelerometer; and performing an operation associated with at least one camera based on the movement.

### BRIEF DESCRIPTION OF THE DRAWINGS

The above and other aspects, features and advantages of the disclosure will be more apparent from the following detailed description, taken in conjunction with the accompanying drawings, in which:

FIG. 1A is a diagram of an example of an electronic device, according to various embodiments of the present disclosure;

FIG. 1B is a diagram of an example of a network environment, according to embodiments of the present disclosure;

FIG. 2 is a block diagram of an example of an electronic device, according to to various embodiments of the present disclosure;

FIG. 3 is a flowchart of an example of a process, according to various embodiments of the present disclosure;

FIG. 4A is a diagram showing an example of the operation of an electronic device, according to various embodiments of the present disclosure;

FIG. 4B is a diagram showing an example of the operation of an electronic device, according to various embodiments of the present disclosure;

FIG. 4C is a diagram showing an example of the operation of an electronic device, according to various embodiments of the present disclosure;

FIG. 5A is a graph showing acceleration experienced by an electronic device, according to various embodiments of the present disclosure;

FIG. 5B is a graph showing acceleration experienced by an electronic device, according to various embodiments of the present disclosure;

FIG. 5C is a graph showing acceleration experienced by an electronic device, according to various embodiments of the present disclosure; and

FIG. 6 is a graph illustrating an example of a preset period following a movement of an electronic device, according to various embodiments of the present disclosure.

### DETAILED DESCRIPTION

Hereinafter, various embodiments of the present disclosure will be described with reference to the accompanying drawings. The present disclosure may have various embodiments, and modifications and changes may be made therein. Therefore, the present disclosure will be described in detail with reference to particular embodiments shown in the accompanying drawings. However, it should be to understood that there is no intent to limit the present disclosure to the particular forms, and the present disclosure should be construed to cover all modifications, equivalents, and/or alternatives falling within the spirit and scope of the present disclosure. In describing the drawings, similar elements are designated by similar reference numerals.

As used in the present disclosure, the expression “include” or “may include” refers to the existence of a corresponding function, operation, or constituent element, and does not limit one or more additional functions, operations, or constituent elements. Further, as used in the present disclosure, the term such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

As used in the present disclosure, the expression “or” includes any or all combinations of words enumerated together. For example, the expression “A or B” may include A, may include B, or may include both A and B.

While expressions including ordinal numbers, such as “first” and “second”, as used in the present disclosure may modify various constituent elements, such constituent elements are not limited by the above expressions. For example, the above expressions do not limit the sequence and/or importance of the corresponding constituent elements. The above expressions may be used merely for the purpose of distinguishing a constituent element from other constituent elements. For example, a first user device and a second user device indicate different user devices although both are user devices. For example, a first constituent element may be termed a to second constituent element, and likewise a second constituent element may also be termed a first constituent element without departing from the scope of the present disclosure.

When a component is referred to as being “connected” or “accessed” to any other component, it should be understood that the component may be directly connected or accessed to the other component, but another new component may also be interposed between them. Contrarily, when a component is referred to as being “directly connected” or “directly accessed” to any other component, it should be understood that there is no new component between the component and the other component.

The terms as used in various embodiments of the present disclosure are merely for the purpose of describing particular embodiments and are not intended to limit the present disclosure. Singular forms are intended to include plural forms unless the context clearly indicates otherwise.

Unless defined otherwise, all terms used herein, including technical terms and scientific terms, have the same meaning as commonly understood by a person of ordinary skill in the art to which the present disclosure pertains. Such terms as those defined in a generally used dictionary are to be interpreted to have the meanings equal to the contextual meanings in the relevant field of art, and are not to be interpreted to have ideal or excessively formal meanings unless clearly defined in the present disclosure.

An electronic device according to various embodiments of the present disclosure may be a device including a communication function. For example, the electronic device may be one or more of the following: a smartphone, a tablet Personal Computer (tablet PC), a mobile phone, a video phone, an e-book reader, a to desktop personal computer (desktop PC), a laptop personal computer (laptop PC), a netbook computer, a Personal Digital Assistant (PDA), Portable Multimedia Player (PMP), MP3 player, a mobile medical application, a camera, and a wearable device (for example, a Head-Mounted-Device (HMD), such as electronic glasses, electronic clothes, an electronic bracelet, an electronic necklace, an electronic appcessory, an electronic tattoo, and a smart watch).

According to some embodiments, the electronic device may be a smart home appliance with a communication function. The smart home appliance may include at least one of the following: a television, a Digital Video Disk (DVD) player, an audio player, an air conditioner, a cleaner, an oven, a microwave oven, a washing machine, an air purifier, a set-top box, a TV box (e.g., Samsung HomeSync™, Apple TV™, or Google TV™), game consoles, an electronic dictionary, an electronic key, a camcorder, and an electronic frame.

According to some embodiments, the electronic device may include at least one of the following: various types of medical devices (e.g., Magnetic Resonance Angiography (MRA), Magnetic Resonance Imaging (MRI), Computed Tomography (CT), a scanner, an ultrasonic device, etc.), a navigation device, a Global Positioning System (GPS) receiver, an event data recorder (EDR), a flight data recorder (FDR), a vehicle infotainment device, electronic equipment for a ship (e.g., a navigation device for ship, a gyro compass and the like), avionics, a security device, a head unit for a vehicle, an industrial or home robot, an automatic teller machine (ATM) of financial institutions, and a point of sale (POS) device of shops.

According to some embodiments, the electronic device may include at least one of the following: furniture or part of a building/structure, an electronic board, an electronic signature receiving device, a projector, and various types of measuring to devices (e.g., a water meter, an electricity meter, a gas meter, a radio wave meter, etc.), which are equipped with a communication function. The electronic device according to various embodiments of the present disclosure may also be a combination of the devices listed above. Further, the electronic device according to various embodiments of the present disclosure may be a flexible device. It is apparent to those skilled in the art that the electronic device according to various embodiments of the present disclosure is not limited to the above-described devices.

Hereinafter, an electronic device according to various embodiments will be discussed with reference to the accompanying drawings. The term “user” as used in various embodiments may refer to any person who uses an electronic device or any other device (e.g., an artificial intelligence electronic device) using an electronic device.

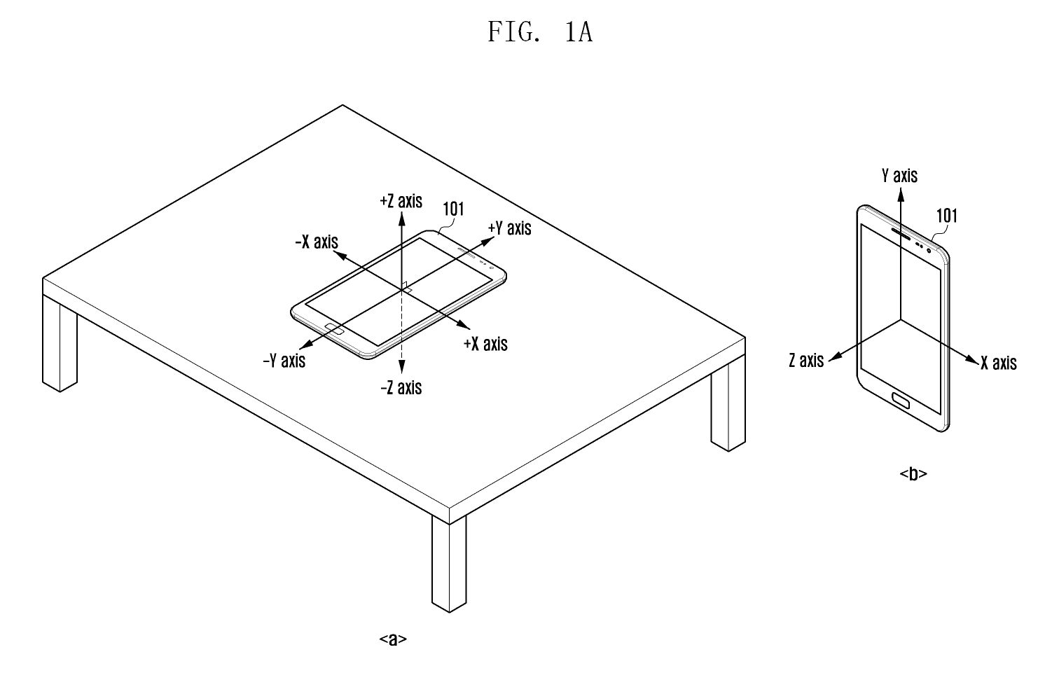

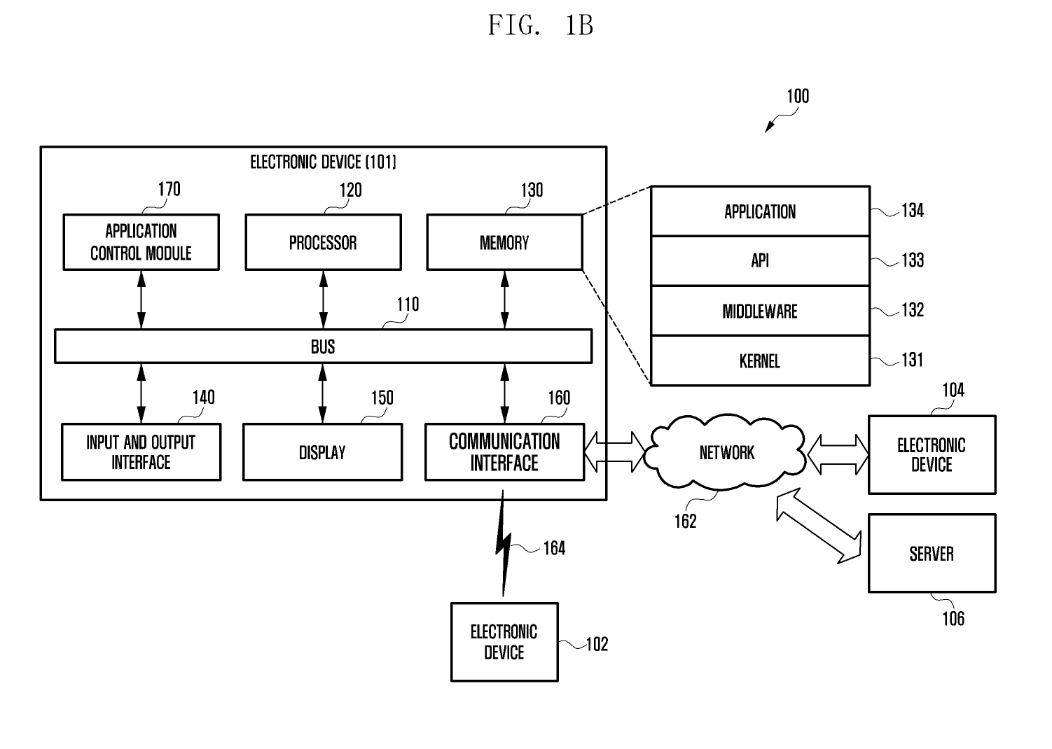

FIG. 1A is a diagram of an example of an electronic device, according to various embodiments of the present disclosure. More particularly, FIG. 1A illustrates the operation of a method of sensing accelerations in the 3-axis directions (x-, y- and z-axes) in an electronic device 101 according to various embodiments of the present disclosure.

The electronic device 101 may detect that it has moved by using an accelerometer. The accelerometer may measure acceleration values of the electronic device 101 in the x-, y-, and z-axes, with respect to the electronic device 101. The accelerometer may detect the movement state of the electronic device 101 using the acceleration values. For example, referring to diagram 110 shown in FIG. 1A, when the electronic device 101 is placed horizontally or parallel to the ground, the accelerometer of the electronic device 101 may measure a gravitational acceleration of 9.8 m/s2 in the z-axis direction (i.e., the direction of the earth center). As illustrated to in FIG. 1A, when the electronic device 101 is set vertically or perpendicular to the ground, the accelerometer of the electronic device 101 may measure a gravitational acceleration of 9.8 m/s2 in the y-axis direction (i.e., the direction of the earth center). When the electronic device 101 is set (sloped or tilted) at a certain angle with respect to the ground, the accelerometer of the electronic device 101 may also measure accelerations in individual axes. When the electronic device 101 is placed in a specific position, the accelerometer of the electronic device 101 may measure accelerations for the position in individual axes. That is, the accelerometer of the electronic device 101 may measure accelerations in individual axes with respect to the electronic device 101, and detecting the movement of the electronic device 101 based on the measured accelerations in individual axes.

FIG. 1B is a diagram of an example of a network environment 100 including therein an electronic device 101 in accordance with an embodiment of the present disclosure. Referring to FIG. 1, the electronic device 101 may include, but not limited to, a bus 110, a processor 120, a memory 130, an input/output interface 140, a display 150, a communication interface 160, and an application control module 170.

The bus 110 may be a circuit designed for connecting the above-discussed elements and communicating data (e.g., a control message) between such elements.

The processor 120 may include any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. For example, the processor 120 may receive commands from the other elements (e.g., the memory 130, the input/output interface 140, the display 150, the communication interface 160, or the application control module 170, etc.) through the to bus 110, interpret the received commands, and perform the arithmetic or data processing based on the interpreted commands.

The memory 130 may include any suitable type of volatile or non-volatile memory, such as Random-access Memory (RAM), Read-Only Memory (ROM), Network Accessible Storage (NAS), cloud storage, a Solid State Drive (SSD), etc. The memory 130 may store therein commands or data received from or created by the processor 120 or other elements (e.g., the input/output interface 140, the display 150, the communication interface 160, or the application control module 170, etc.). The memory 130 may include programming modules such as a kernel 131, a middleware 132, an application programming interface (API) 133, and an application 134. Each of the programming modules may be composed of software, firmware, hardware, and any combination thereof.

The kernel 131 may control or manage system resources (e.g., the bus 110, the processor 120, or the memory 130, etc.) used for performing operations or functions of the other programming modules, e.g., the middleware 132, the API 133, or the application 134. Additionally, the kernel 131 may offer an interface that allows the middleware 132, the API 133 or the application 134 to access, control or manage individual elements of the electronic device 101.

The middleware 132 may perform intermediation by which the API 133 or the application 134 communicates with the kernel 131 to transmit or receive data. Additionally, in connection with task requests received from the applications 134, the middleware 132 may perform a control (e.g., scheduling or load balancing) for the task request by using technique such as assigning the priority for using a system resource of the electronic device 101 (e.g., the bus 110, the processor 120, or the memory 130, etc.) to at least one of the applications 134.

The API 133 which is an interface for allowing the application 134 to control a function provided by the kernel 131 or the middleware 132 may include, for example, at least one interface or function (e.g., a command) for a file control, a window control, an image processing, a text control, and the like.

According to embodiments, the application 134 may include an SMS/MMS application, an email application, a calendar application, an alarm application, a health care application (e.g., an application for measuring quantity of motion or blood sugar), an environment information application (e.g., an application for offering information about atmospheric pressure, humidity, or temperature, etc.), and the like. Additionally or alternatively, the application 134 may be an application associated with an exchange of information between the electronic device 101 and any external electronic device (e.g., an external electronic device 104). This type application may include a notification relay application for delivering specific information to an external electronic device, or a device management application for managing an external electronic device.

For example, the notification relay application may include a function to deliver notification information created at any other application of the electronic device 101 (e.g., the SMS/MMS application, the email application, the health care application, or the environment information application, etc.) to an external electronic device (e.g., the electronic device 104). Additionally or alternatively, the notification relay application may receive notification information from an external electronic device (e.g., the electronic device 104) and offer it to a user. The device management application may manage (e.g., install, remove or update) a certain function (a turn-on/turn-off of an external electronic device (or some components thereof), or an adjustment of brightness (or resolution) of a display) of any external electronic device to (e.g., the electronic device 104) communicating with the electronic device 101, a certain application operating at such an external electronic device, or a certain service (e.g., a call service or a message service) offered by such an external electronic device.

According to embodiments, the application 134 may include a specific application specified depending on attributes (e.g., a type) of an external electronic device (e.g., the electronic device 104). For example, in case an external electronic device is an MP3 player, the application 134 may include a specific application associated with a play of music. Similarly, in case an external electronic device is a portable medical device, the application 134 may include a specific application associated with a health care. In an embodiment, the application 134 may include at least one of an application assigned to the electronic device 101 or an application received from an external electronic device (e.g., the server 106 or the electronic device 104).

The input/output interface 140 may deliver commands or data, entered by a user through an input/output unit (e.g., a sensor, a keyboard, or a touchscreen), to the processor 120, the memory 130, the communication interface 160, or the application control module 170 via the bus 110. For example, the input/output interface 140 may offer data about a user's touch, entered through the touchscreen, to the processor 120. Also, through the input/output unit (e.g., a speaker or a display), the input/output interface 140 may output commands or data, received from the processor 120, the memory 130, the communication interface 160, or the application control module 170 via the bus 110. For example, the input/output interface 140 may output voice data, processed through the processor 120, to a user through the speaker.

The display 150 may display thereon various kinds of information (e.g., multimedia data, text data, etc.) to a user.

The communication interface 160 may exchange communications with any external electronic device (e.g., the electronic device 104 of the server 106). For example, the communication interface 160 may communicate with any external device by being connected to a network 162 through a wired or wireless connection. A wireless communication may include, but not limited to, at least one of WiFi (Wireless Fidelity), BT (Bluetooth), NFC (Near Field Communication), GPS (Global Positioning System), or a cellular communication (e.g., LTE, LTE-A, CDMA, WCDMA, UMTS, WiBro, or GSM, etc.). Wired communication may include, but not limited to, at least one of USB (Universal Serial Bus), HDMI (High Definition Multimedia Interface), RS-232 (Recommended Standard 232), or POTS (Plain Old Telephone Service).

According to an embodiment, the network 162 may be a communication network, which may include at least one of a computer network, the Internet, an internet of things, or a telephone network. According to an embodiment, a protocol (e.g., transport layer protocol, data link layer protocol, or physical layer protocol) for a communication between the electronic device 101 and any external device may be supported by at least one of the application 134, the API 133, the middleware 132, the kernel 131, or the communication interface 160.

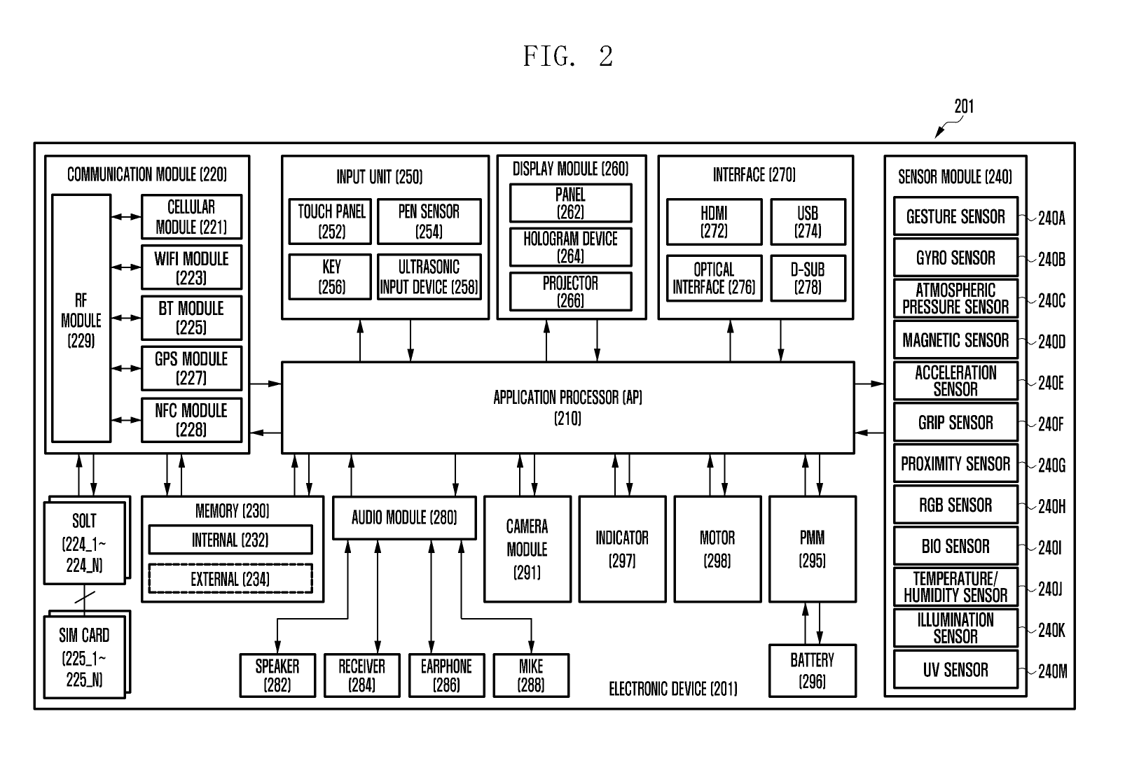

The application control module 170 may process at least part of the information obtained from the other elements (e.g., the processor 120, the memory 130, the input/output interface 140, or the communication interface 160, etc.) and then offer it to a user in various ways. For example, the application control module 170 may recognize information about access components provided in the electronic device 101, store such information in the memory 130, and execute the application to 134 on the basis of such information. A further description of the application control module 170 will be given hereinafter through FIGS. 2 to 7.

FIG. 2 is a block diagram of an example of an electronic device 201, according to various embodiments of the present disclosure. For example, the electronic device may be configured to include part of all of the electronic device shown in FIG. 1A.

FIG. 2 is a block diagram illustrating an electronic device 201 in accordance with an embodiment of the present disclosure. The electronic device 201 may form, for example, the whole or part of the electronic device 101 shown in FIG. 1. Referring to FIG. 2, the electronic device 201 may include at least one application processor (AP) 210, a communication module 220, a subscriber identification module (SIM) card 224, a memory 230, a sensor module 240, an input unit 250, a display 260, an interface 270, an audio module 280, a camera module 291, a power management module 295, a battery 296, an indicator 297, and a motor 298.

The AP 210 may drive an operating system or applications, control a plurality of hardware or software components connected thereto, and also perform processing and operation for various data including multimedia data. The AP 210 may be formed of system-on-chip (SoC), for example. According to an embodiment, the AP 210 may further include a graphic processing unit (GPU) (not shown).

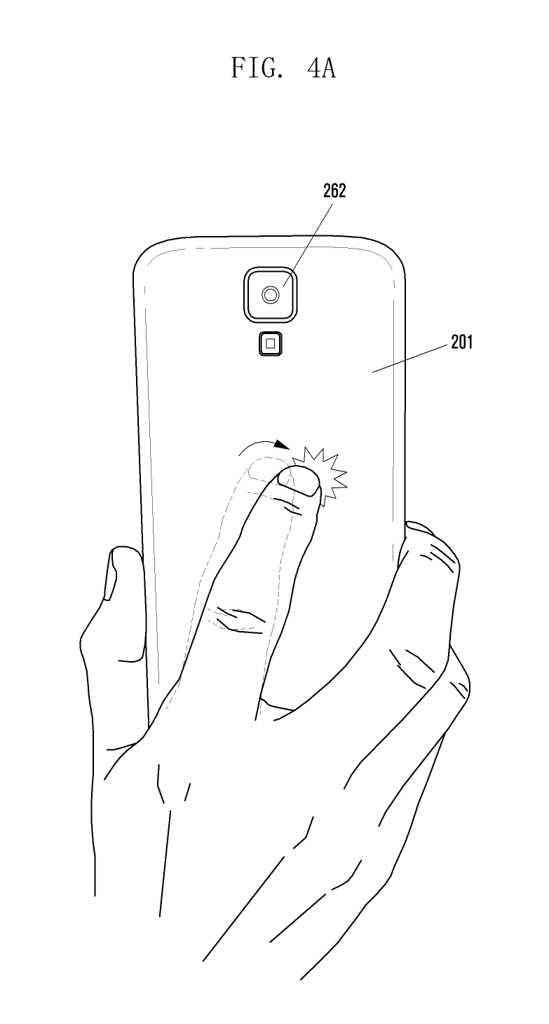

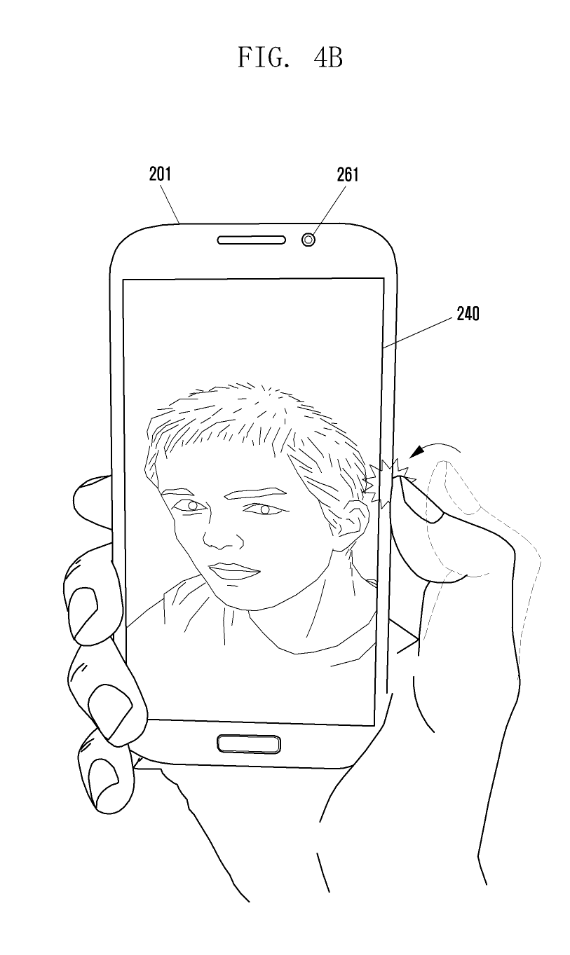

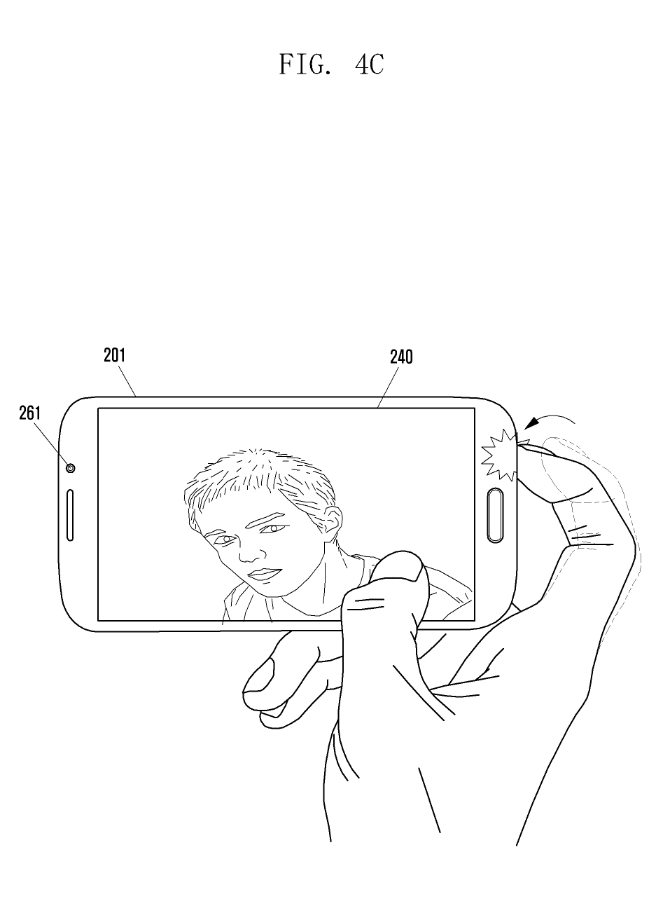

The processor 210, according to various embodiments of the present disclosure, may determine whether the electronic device 201 is in a stationary state. When the processor 210 detects that the x-, y-, and z-axis acceleration variations measured by the accelerometer 240e are within a preset range for a preset period of time, it determines that the electronic device 201 is in a stationary state. When the electronic device 201 is in a stationary state, the processor 210 detects a movement to of the electronic device 201 that is performed in response to an action that is performed on the electronic device 201 while the electronic device 200 is in a camera standby mode. The movement may be caused by any suitable type of action, such as a tap, an impact and a shake. For example, the user may tap on the back of the electronic device, on the front or side of the electronic device 201, or on the touchscreen of the electronic device 201. Additionally or alternatively, the movement of the electronic device 201 may be caused by the user holding and inclining the electronic device 201 in a particular direction at a certain angle, etc. Movement of the electronic device 201 may be changed according to the actions. The change in movement of the electronic device 201 corresponding to individual actions will be described later referring to FIGS. 4A to 4C.

The processor 210 according to various embodiments of the present disclosure may detect a movement of the electronic device 201 using at least one of the variations of x-axis acceleration value, y-axis acceleration value and z-axis acceleration value (i.e., each of the x-, y- and z-axis acceleration values), measured by the accelerometer 240e. For example, when the user taps on the back of the electronic device 201, the z-axis acceleration value may be varied according to the tap. The processor 210 ascertains that the larger the variation of the z-axis acceleration value, the more the electronic device 201 moves in the z-axis direction. The processor 210 may also detect whether the electronic device 201 moves in +z-axis or −z-axis direction, according to whether the z-axis acceleration value increases or decreases.

The processor 210 according to various embodiments of the present disclosure may control the camera module 291 to perform camera-related operations, e.g., image capturing, taking a video, etc., based on a movement of the electronic to device 201. The processor 210 may determine whether one of the variations of each of the x-, y- and z-axis acceleration values, measured by the accelerometer 240e, is greater than or equal to a preset value. When the processor 210 detects that one of the variations of each of the x-, y- and z-axis acceleration values, measured by the accelerometer 240e, is greater than or equal to a preset value, it may control the camera module 291 to perform one or more operations that are related to the camera. For example, when the processor 210 detects that the variation of a z-axis acceleration value measured by the accelerometer 240e is greater than or equal to a preset value, it may control the camera module 291 to perform operations related to the camera.

The communication module 220 (e.g., the communication interface 160) may perform a data communication with any other electronic device (e.g., the electronic device 104 or the server 106) connected to the electronic device 200 (e.g., the electronic device 101) through the network. According to an embodiment, the communication module 220 may include therein a cellular module 221, a WiFi module 223, a BT module 225, a GPS module 227, an NFC module 228, and an RF (Radio Frequency) module 229.

The cellular module 221 may offer a voice call, a video call, a message service, an internet service, or the like through a communication network (e.g., LTE, LTE-A, CDMA, WCDMA, UMTS, WiBro, or GSM, etc.). Additionally, the cellular module 221 may perform identification and authentication of the electronic device in the communication network, using the SIM card 224. According to an embodiment, the cellular module 221 may perform at least part of functions the AP 210 can provide. For example, the cellular module 221 may perform at least part of a multimedia control function.

According to an embodiment, the cellular module 221 may include a communication processor (CP). Additionally, the cellular module 221 may be formed of SoC, for example. Although some elements such as the cellular module 221 (e.g., the CP), the memory 230, or the power management module 295 are shown as separate elements being different from the AP 210 in FIG. 2, the AP 210 may be formed to have at least part (e.g., the cellular module 221) of the above elements in an embodiment.

According to an embodiment, the AP 210 or the cellular module 221 (e.g., the CP) may load commands or data, received from a nonvolatile memory connected thereto or from at least one of the other elements, into a volatile memory to process them. Additionally, the AP 210 or the cellular module 221 may store data, received from or created by one or more of the other elements, in the nonvolatile memory.

Each of the WiFi module 223, the BT module 225, the GPS module 227 and the NFC module 228 may include a processor for processing data transmitted or received therethrough. Although FIG. 2 shows the cellular module 221, the WiFi module 223, the BT module 225, the GPS module 227 and the NFC module 228 as different blocks, at least part of them may be contained in a single IC (Integrated Circuit) chip or a single IC package in an embodiment. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227 and the NFC module 228 may be formed as a single SoC.

The RF module 229 may transmit and receive data, e.g., RF signals or any other electric signals. Although not shown, the RF module 229 may include a transceiver, a PAM (Power Amp Module), a frequency filter, an LNA (Low Noise to Amplifier), or the like. Also, the RF module 229 may include any component, e.g., a wire or a conductor, for transmission of electromagnetic waves in a free air space. Although FIG. 2 shows that the cellular module 221, the WiFi module 223, the BT module 225, the GPS module 227 and the NFC module 228 share the RF module 229, at least one of them may perform transmission and reception of RF signals through a separate RF module in an embodiment.

The SIM card 224_1 to 224_N may be a specific card formed of SIM and may be inserted into a slot 225_1 to 225_N formed at a certain place of the electronic device. The SIM card 224_1 to 224_N may contain therein an ICCID (Integrated Circuit Card IDentifier) or an IMSI (International Mobile Subscriber Identity).

The memory 230 (e.g., the memory 130) may include an internal memory 232 and an external memory 234. The internal memory 232 may include, for example, at least one of a volatile memory (e.g., DRAM (Dynamic RAM), SRAM (Static RAM), SDRAM (Synchronous DRAM), etc.) or a nonvolatile memory (e.g., OTPROM (One Time Programmable ROM), PROM (Programmable ROM), EPROM (Erasable and Programmable ROM), EEPROM (Electrically Erasable and Programmable ROM), mask ROM, flash ROM, NAND flash memory, NOR flash memory, etc.).

According to an embodiment, the internal memory 232 may have the form of an SSD (Solid State Drive). The external memory 234 may include a flash drive, e.g., CF (Compact Flash), SD (Secure Digital), Micro-SD (Micro Secure Digital), Mini-SD (Mini Secure Digital), xD (eXtreme Digital), memory stick, or the like. The external memory 234 may be functionally connected to the electronic device 200 through various interfaces. According to an embodiment, the electronic device 200 may further include a storage device or medium such as a hard drive.

The memory 230 according to various embodiments of the present disclosure to may store instructions, which when executed by the processor 210, cause the processor 210 to detect a movement of the electronic device 201, measured by the accelerometer 240e, and to perform at least one camera-related operation based on the detected movement. The memory 230 may store an instruction for causing the processor 210 to command the camera 291-1 to enter a camera standby mode, according to a camera application executing command from the user. The memory 230 may store an instruction for causing the processor 210 to determine whether the electronic device 201 is in a stationary state. The memory 230 may store an instruction for causing the processor 210 to detect, when the electronic device 201 is in a stationary state, a movement of the electronic device 201 in response to an action that is performed on the electronic device 201. The memory 230 may store an instruction for enabling the processor 210 to detect that the electronic device 201 is in a stationary state when x-, y- and z-axis acceleration variations, measured by the accelerometer 240e, are within a preset range for a preset period of time. The memory 230 may store an instruction for causing the processor 210 to detect a movement of the electronic device 201 using at least one of the following: x-, y- and z-axis acceleration variations, measured by the accelerometer 240e. The memory 230 may store an instruction for causing the processor 210 to perform a camera-related operation after a preset period of time has elapsed since detecting the movement of the electronic device 201. The memory 230 may store an instruction for causing the processor 210 to perform a camera-related operation when any movement of the electronic device 201 is not detected for a preset period of time since the movement of the electronic device 201 is detected. The memory 230 according to various embodiments of the present disclosure may store images that are captured by the camera module 291.

The sensor module 240 may measure a particular physical quantity or sense an operating status of the electronic device 200, and then convert measured or sensed information into electric signals. The sensor module 240 may include, for example, at least one of a gesture sensor 240A, a gyro sensor 240B, an atmospheric sensor 240C, a magnetic sensor 240D, an acceleration sensor 240E, a grip sensor 240F, a proximity sensor 240G, a color sensor 240H (e.g., RGB (Red, Green, Blue) sensor), a biometric sensor 240I, a temperature-humidity sensor 240J, an illumination sensor 240K, and a UV (ultraviolet) sensor 240M. Additionally or alternatively, the sensor module 240 may include, e.g., an E-nose sensor (not shown), an EMG (electromyography) sensor (not shown), an EEG (electroencephalogram) sensor (not shown), an ECG (electrocardiogram) sensor (not shown), an IR (infrared) sensor (not shown), an iris scan sensor (not shown), or a finger scan sensor (not shown). Also, the sensor module 240 may include a control circuit for controlling one or more sensors equipped therein.

The input unit 250 may include a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. In case of a capacitive type, a physical contact or proximity may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 may be a device capable of identifying data by sensing sound waves to with a microphone 288 in the electronic device 200 through an input tool that generates ultrasonic signals, thus allowing wireless recognition. According to an embodiment, the electronic device 200 may receive a user input from any external device (e.g., a computer or a server) connected thereto through the communication module 220.

The display 260 (e.g., the display 150) may include a panel 262, a hologram 264, or a projector 266. The panel 262 may be, for example, LCD (Liquid Crystal Display), AM-OLED (Active Matrix Organic Light Emitting Diode), or the like. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located on the inside or outside of the electronic device 200. According to an embodiment, the display 260 may further include a control circuit for controlling the panel 262, the hologram 264, and the projector 266.

The interface 270 may include, for example, an HDMI (High-Definition Multimedia Interface) 272, a USB (Universal Serial Bus) 274, an optical interface 276, or a D-sub (D-subminiature) 278. The interface 270 may be contained, for example, in the communication interface 160 shown in FIG. 1. Additionally or alternatively, the interface 270 may include, for example, an MHL (Mobile High-definition Link) interface, an SD (Secure Digital) card/MMC (Multi-Media Card) interface, or an IrDA (Infrared Data Association) interface.

The audio module 280 may perform a conversion between sounds and electric signals. At least part of the audio module 280 may be contained, for example, in the input/output interface 140 shown in FIG. 1. The audio module 280 may process to sound information inputted or outputted through a speaker 282, a receiver 284, an earphone 286, or a microphone 288.

The camera module 291 may be capable of obtaining still images and moving images. According to an embodiment, the camera module 291 may include at least one image sensor (e.g., a front sensor or a rear sensor), a lens (not shown), an ISP (Image Signal Processor, not shown), or a flash (e.g., LED or xenon lamp, not shown).

The camera module 291 according to various embodiments of the present disclosure may perform various camera-related operations, e.g., image capturing, video capturing, etc., based on a movement of the electronic device 201. When one of the variations of x-axis acceleration value 510, y-axis acceleration value 520 and z-axis acceleration value 530, measured by the accelerometer 240e, is greater than or equal to a preset value, the camera module 291 may capture an image of a subject under the control of the processor 210.

The power management module 295 may manage the power supply of the electronic device 200. Although not shown, the power management module 295 may include, for example, a PMIC (Power Management Integrated Circuit), a charger IC, or a battery or fuel gauge.

The PMIC may be formed, for example, of an IC chip or SoC. Charging may be performed in a wired or wireless manner. The charger IC may charge a battery 296 and prevent overvoltage or overcurrent from a charger. According to an embodiment, the charger IC may have a charger IC used for at least one of wired and wireless charging types. A wireless charging type may include, for example, a magnetic resonance type, a magnetic induction type, or an electromagnetic type. Any to additional circuit for a wireless charging may be further used such as a coil loop, a resonance circuit, or a rectifier.

The battery gauge may measure the residual amount of the battery 296 and a voltage, current or temperature in a charging process. The battery 296 may store or create electric power therein and supply electric power to the electronic device 200. The battery 296 may be, for example, a rechargeable battery or a solar battery.

The indicator 297 may show thereon a current status (e.g., a booting status, a message status, or a recharging status) of the electronic device 200 or of its part (e.g., the AP 210). The motor 298 may convert an electric signal into a mechanical vibration. Although not shown, the electronic device 200 may include a specific processor (e.g., GPU) for supporting a mobile TV. This processor may process media data that comply with standards of DMB (Digital Multimedia Broadcasting), DVB (Digital Video Broadcasting), or media flow.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before integrated.

The term “module” used in this disclosure may refer to a certain unit that includes one of hardware, software and firmware or any combination thereof. The module may be interchangeably used with unit, logic, logical block, component, or circuit, for example. The module may be the minimum unit, or part thereof, which performs one or more particular functions. The module may be formed mechanically to or electronically. For example, the module disclosed herein may include at least one of ASIC (Application-Specific Integrated Circuit) chip, FPGAs (Field-Programmable Gate Arrays), and programmable-logic device, which have been known or are to be developed.

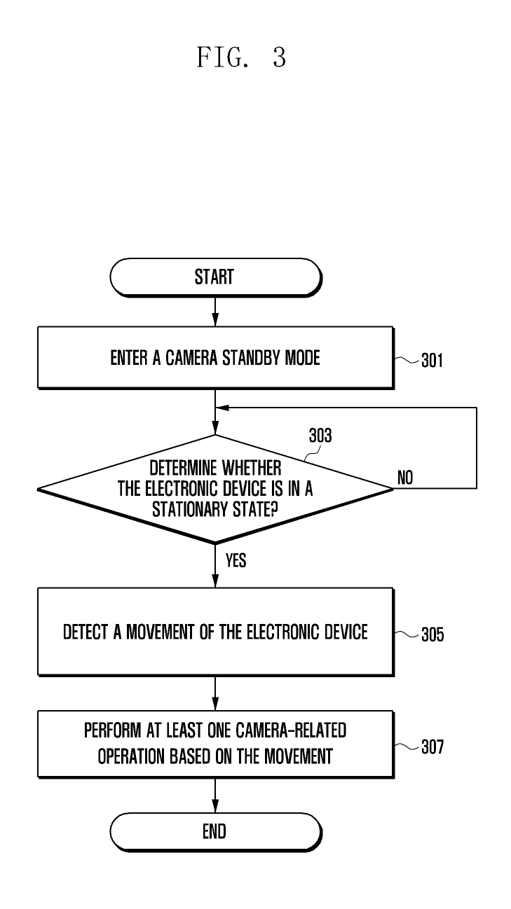

FIG. 3 is a flowchart of an example of a process, according to various embodiments of the present disclosure.

The electronic device 201 is may enter a camera standby mode in operation 301. The electronic device 201 may receive a user input for executing a camera application from the input device 250 and execute the camera application according to the input. When the camera module 291 is enabled according to the execution of the camera application, the electronic device 201 may detect a user input for running the front camera 261 or the rear camera. While the camera module 291 is in a camera standby mode, the electronic device 201 processes images taken by the camera module 291 and then output the images as preview images of N frames per second onto the display 260.

The electronic device 201 may detect whether it is in a stationary state in operation 303.

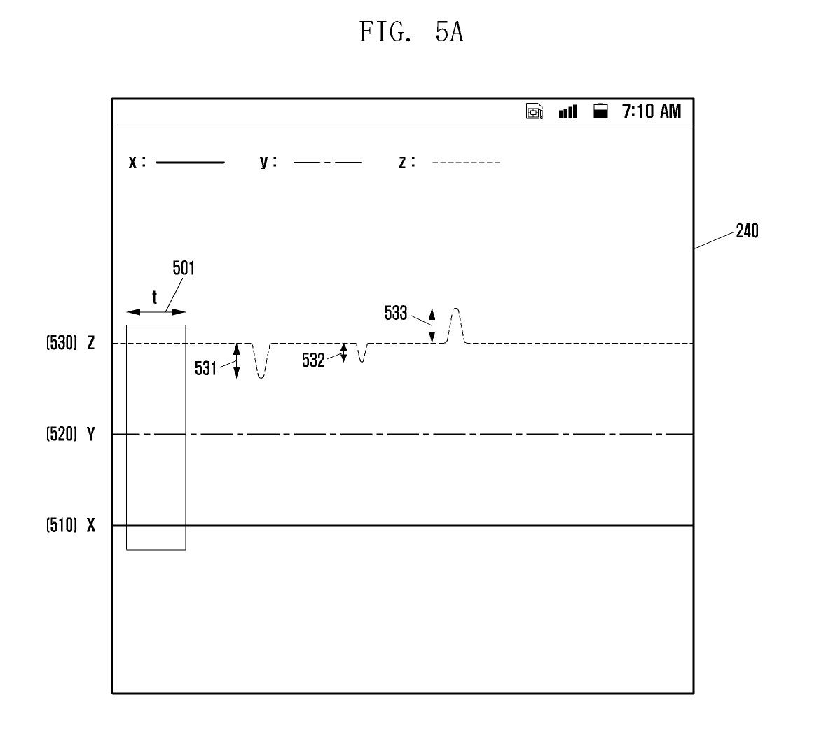

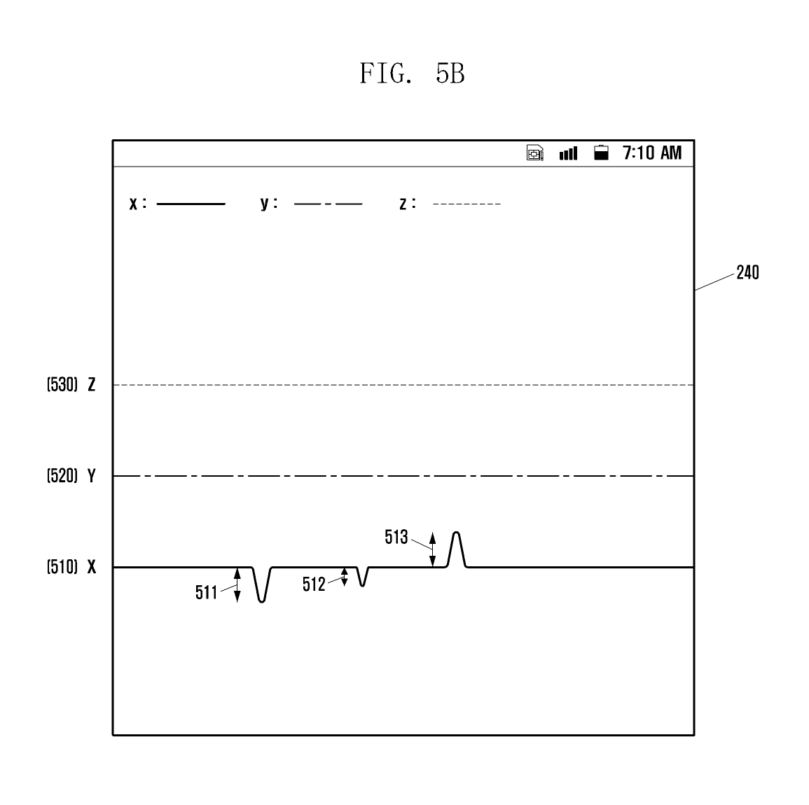

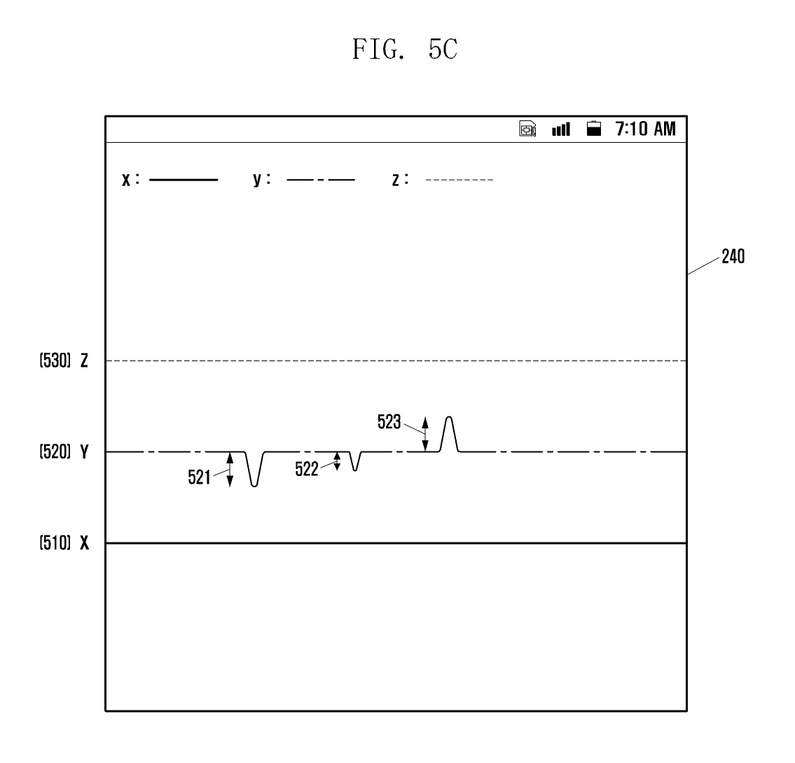

When the electronic device 201 according to various embodiments of the present disclosure has x-, y- and z-axis acceleration variations, measured by the accelerometer 240e, within a preset range, for a preset period of time t, the processor may determine that the electronic device 201 is in a stationary state. The preset period of time t and the preset range may be set by the user or the manufacturer in the process of manufacturing the electronic device. For example, when a 3-axis acceleration variation, measured by the accelerometer 240e, is 0˜0.2 m/s² for two seconds, it is assumed that the electronic device 201 is in a stationary to state. Referring to FIG. 5A, when detecting that a 3-axis acceleration variation of the electronic device 201 is 0˜0.2 m/s² for an interval 501 of t, the processor may determine that the electronic device 201 is in a stationary state.

When the electronic device 201 is not in a stationary state in operation 303, it repeats operation 303 and remains in the camera standby mode. While the electronic device 201 is in a camera standby mode, it may determine whether it is stationary so that the user can take a photograph by using the camera.

When the electronic device 201 is in a stationary state in operation 303, it may detect that it has moved by using the accelerometer 240e, in operation 305.

According to various embodiments of the present disclosure, the user of the electronic device 201 may perform any suitable type of action on the electronic device 201. For example, referring to FIG. 4A, in order to take a selfie in the portrait orientation, the user runs the front camera 261 and taps the back of the electronic device 201. The electronic device may detect the tap by based on a motion of the electronic device that is performed as a result of the tap, and afterwards, the electronic device may capture an image (or perform another camera-related operation) in response to the tap. Referring to FIG. 4B, in order to take a selfie in the portrait orientation, the user runs the front camera 261 and taps the side of the electronic device 201. The electronic device may then detect the tap by detecting a motion of the electronic device that is performed as a result of the tap, and may then capture an image in response to the tap (or perform another camera-related function). Referring to FIG. 4C, in order to take a selfie in the landscape orientation, the user runs the front camera 261 and taps the side (an absolute bottom side) of the electronic device 201. The electronic device 201 may detect the tap based on a motion that is performed by the electronic device as a result of the tap, and to subsequently may capture an image or perform another camera-related operation. it. It should be understood that the actions which the user can perform on the electronic device 201 are not limited to the examples described above. That is, it should be understood that the present disclosure may include any suitable type of action that can cause the electronic device 201 to move.

The electronic device 201 may detect that it has moved as a result of an action that is performed on the electronic device 201. The electronic device 201 may detect its movement based on at least one of the variations of each of the x-, y- and z-axis acceleration values, measured by the accelerometer 240e.

The electronic device 201 according to various embodiments of the present disclosure may detect that it has moved based on the variation of a z-axis acceleration value 530, measured by the accelerometer 240e. For example, as shown in FIG. 4A, when the user runs the front camera 261 and taps on the back of the electronic device 201 in order to take a selfie in the portrait orientation, the z-axis acceleration value 530 may vary in response to the tap as shown in FIG. 5A. The processor of the electronic device 201 ascertains that the larger the variation of the z-axis acceleration value 530, the more the electronic device 201 moves in the z-axis direction. The processor of the electronic device 201 may also detect that the electronic device 201 moves in +z-axis or −z-axis direction, according to whether the z-axis acceleration value 530 increases or decreases. For example, when the accelerometer 240e of the electronic device 201 measures a first variation 531, second variation 532, and third variation 533 of the z-axis acceleration value, the processor of the electronic device 201 detects that the magnitude of the movement when the electronic device 201 measures the first variation 531 is greater than that when measuring the second variation 532. When the movement when measuring the to first variation 531 is the movement in the +z-axis direction, the processor of the electronic device 201 detects that the movement when measuring the third variation 533 corresponds to that in the −z-axis direction.

The electronic device 201 according to various embodiments of the present disclosure may detect its movement, by using the variation of an x-axis acceleration value 510, measured by the accelerometer 240e. For example, as shown in FIG. 4B, when the user runs the front camera 261 and taps on the side of the electronic device 201 in order to take a selfie in the portrait orientation, the x-axis acceleration value 510 may vary in response to the tap as shown in FIG. 5B. The processor of the electronic device 201 ascertains that the larger the variation of the x-axis acceleration value 510, the more the electronic device 201 moves in the x-axis direction. The processor of the electronic device 201 may also detect that the electronic device 201 moves in +x-axis or −x-axis direction, according to whether the x-axis acceleration value 510 increases or decreases. For example, when the accelerometer 240e of the electronic device 201 measures a first variation 511, second variation 512, and third variation 513 of the x-axis acceleration value, the processor of the electronic device 201 detects that the magnitude of the movement when the electronic device 201 measures the first variation 511 is greater than that when measuring the second variation 512. When the movement when measuring the first variation 511 is the movement in the +x-axis direction, the processor of the electronic device 201 detects that the movement when measuring the third variation 513 corresponds to that in the −x-axis direction.

The electronic device 201 according to various embodiments of the present disclosure may detect its movement, by using the variation of a y-axis acceleration value 520, measured by the accelerometer 240e. For example, as shown in FIG. 4C, to when the user runs the front camera 261 and taps on the side of the electronic device 201 in order to take a selfie in the landscape orientation, the y-axis acceleration value 520 may vary in response to the tap as shown in FIG. 5C. The processor of the electronic device 201 detects that the larger the variation of the y-axis acceleration value 520, the more the electronic device 201 moves in the y-axis direction. The processor of the electronic device 201 may also detect that the electronic device 201 moves in +y-axis or −y-axis direction, according to whether the y-axis acceleration value 520 increases or decreases. For example, when the accelerometer 240e of the electronic device 201 measures first variation 521, second variation 522, and third variation 523 of the y-axis acceleration value, the processor of the electronic device 201 detects that the magnitude of the movement when the electronic device 201 measures the first variation 521 is greater than that when measuring the second variation 522. When the movement when measuring the first variation 521 is the movement in the +y-axis direction, the processor of the electronic device 201 detects that the movement when measuring the third variation 523 corresponds to that in the −y-axis direction.

The electronic device 201 may perform at least one camera-related operation based on the detected movement in operation 307. When one of the variations of x-axis acceleration value 510, y-axis acceleration value 520 and z-axis acceleration value 530, measured by the accelerometer 240e, is greater than or equal to a preset value, the electronic device 201 according to various embodiments of the present disclosure may perform at least one camera-related operation, e.g., image capturing, taking a video, etc.

When the variation of a z-axis acceleration value 530 measured by the accelerometer 240e is greater than or equal to a preset value, the electronic device to 201 according to various embodiments of the present disclosure may perform a camera-related operation via the camera module 291. When the variation of a z-axis acceleration value 530 measured by the accelerometer 240e is less than or equal to a preset value, the electronic device 201 controls the camera module 291 to remain in the camera standby mode. For example, it is assumed that the electronic device 201 has set the variation of the z-axis acceleration value 530 to 0.5 m/s² as a condition for taking a selfie as shown in FIG. 4A. In this case, when the absolute value of the first variation 531 of the measured, z-axis acceleration value 530 is 1 m/s² as shown in FIG. 5A, the electronic device 201 detects that the first variation 531 is greater than or equal to a preset value and performs a camera-related operation via the camera module 291. When the absolute value of the second variation 532 of the measured, z-axis acceleration value 530 is 0.25 m/s², the electronic device 201 detects that the second variation 532 is less than or equal to a preset value and remains in the camera standby mode. When the absolute value of the third variation 533 of the measured, z-axis acceleration value 530 is 0.6 m/s², the electronic device 201 detects that the third variation 533 is greater than or equal to a preset value and performs a camera-related operation via the camera module 291. The electronic device 201 may store taken images in the memory 230.

When the variation of an x-axis acceleration value 510 measured by the accelerometer 240e is greater than or equal to a preset value, the electronic device 201 according to various embodiments of the present disclosure may perform a camera-related operation via the camera module 291. When the variation of an x-axis acceleration value 510 measured by the accelerometer 240e is less than or equal to a preset value, the electronic device 201 controls the camera module 291 to remain in the camera standby mode. For example, it is assumed that the electronic to device 201 has set the variation of the x-axis acceleration value 510 to 0.5 m/s² as a condition for taking a selfie as shown in FIG. 4B. In this case, when the absolute value of the first variation 511 of the measured, x-axis acceleration value 510 is 1 m/s² as shown in FIG. 5B, the electronic device 201 detects that the first variation 511 is greater than or equal to a preset value and performs a camera-related operation via the camera module 291. When the absolute value of the second variation 512 of the measured, x-axis acceleration value 510 is 0.25 m/s², the electronic device 201 detects that the second variation 512 is less than or equal to a preset value and remains in the camera standby mode. When the absolute value of the third variation 513 of the measured, x-axis acceleration value 510 is 0.6 m/s², the electronic device 201 detects that the third variation 513 is greater than or equal to a preset value and performs a camera-related operation via the camera module 291. The electronic device 201 may store taken images in the memory 230.

When the variation of a y-axis acceleration value 520 measured by the accelerometer 240e is greater than or equal to a preset value, the electronic device 201 according to various embodiments of the present disclosure may perform a camera-related operation via the camera module 291. When the variation of a y-axis acceleration value 520 measured by the accelerometer 240e is less than or equal to a preset value, the electronic device 201 controls the camera module 291 to remain in the camera standby mode. For example, it is assumed that the electronic device 201 has set the variation of the y-axis acceleration value 520 to 0.5 m/s² as a condition for taking a selfie as shown in FIG. 4C. In this case, when the absolute value of the first variation 521 of the measured, x-axis acceleration value 520 is 1 m/s² as shown in FIG. 5C, the electronic device 201 detects that the first variation 521 is greater than or equal to a preset value and performs a camera-related to operation via the camera module 291. When the absolute value of the second variation 522 of the measured, y-axis acceleration value 520 is 0.25 m/s², the electronic device 201 detects that the second variation 522 is less than or equal to a preset value and remains in the camera standby mode. When the absolute value of the third variation 523 of the measured, y-axis acceleration value 520 is 0.6 m/s², the electronic device 201 detects that the third variation 523 is greater than or equal to a preset value and performs a camera-related operation via the camera module 291. The electronic device 201 may store taken images in the memory 230.

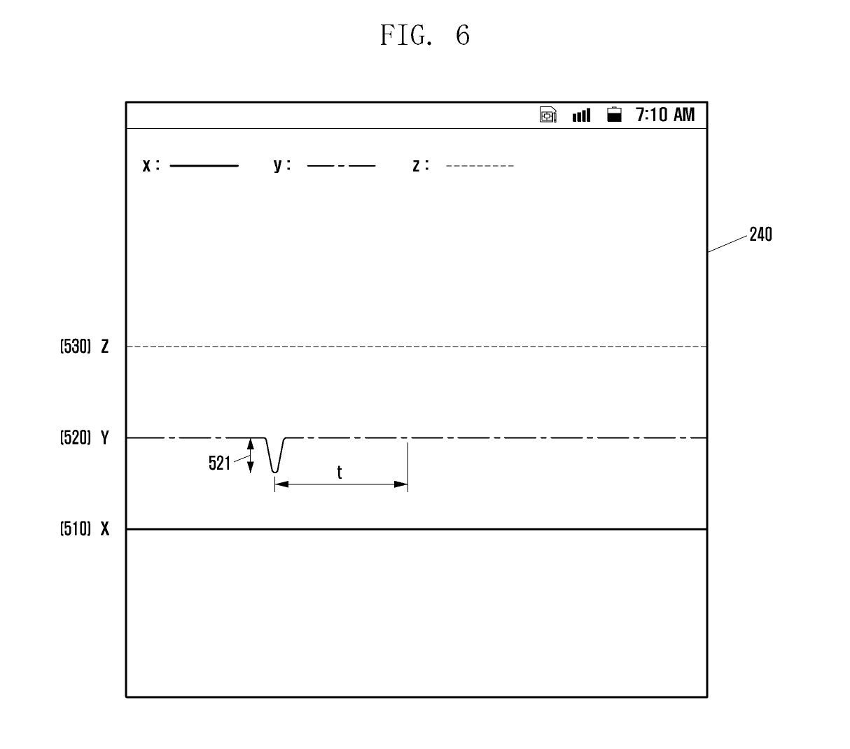

When a preset period of time has elapsed since a movement of the electronic device is detected, the electronic device 201 may perform a camera-related operation. For example, referring to FIG. 6, when the electronic device 201 detects that the variation 521 of the y-axis acceleration value measured by the accelerometer 240e is greater than or equal to a preset value, when a certain period of time t has elapsed, the electronic device 201 may perform a camera-related operation, e.g., image capturing, taking a video, etc.

Since the electronic device 201 according to various embodiments of the present disclosure ascertained its movement, when it has not detected any movement for a preset period of time, may perform a camera-related operation. For example, referring to FIG. 6, when the electronic device 201 detects that the variation 521 of the y-axis acceleration value measured by the accelerometer 240e is greater than or equal to a preset value, when it is in a stationary state without moving for a certain period of time, may perform a camera-related operation, e.g., image capturing, taking a video, etc.

Although it is not shown in the drawings, the electronic device 201 may selectively further include various types of components: a short-range communication to module for short-range communication; an interface for transmitting/receiving data in a wireless or weird mode; an Internet communication module for performing Internet functions; a digital broadcast module for receiving and reproducing broadcasts, etc. With the spread of digital convergence, although it is impossible to list all the modifications in this description, it will be easily appreciated to those skilled in the art that the other components equivalent to the above-listed components may be further included to the electronic device. Also, it will be appreciated that, according to the purposes, the electronic device 201 may be implemented by omitting a particular component or replacing it with other components.

As described above, the method of operation a camera in an electronic device adapted thereto, according to embodiments of the present disclosure, may recognize the change of movement of the electronic device by the accelerometer, thereby simply taking pictures based on the change of movement, instead of taking pictures in an unstable state.

FIGS. 1-6 are provided as an example only. At least some of the operations discussed with respect to these figures can be performed concurrently, performed in different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording to medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

Moreover, the embodiments disclosed in this specification are suggested for the description and understanding of technical content but do not limit the range of the present disclosure. Accordingly, the range of the present disclosure should be interpreted as including all modifications or various other embodiments based on the technical idea of the present disclosure.

1. An electronic device comprising:
at least one camera;
an accelerometer;
a memory; and
at least one processor operatively coupled to the memory, configured to:
detect a movement of the electronic device by using the accelerometer; and
perform an operation associated with the at least one camera based on the movement.

2. The electronic device of claim 1, wherein the at least one processor is further configured to transition the electronic device into a camera standby mode in response to a predetermined command.

3. The electronic device of claim 1, wherein the movement of the electronic device is caused by at least one of an impact, a tap, and a shake of the electronic device.

4. The electronic device of claim 1, wherein:
the at least one processor is further configured to detect whether the electronic device is in a stationary state; and
the movement of the electronic device is detected after detecting that the electronic device is in the stationary state.

5. The electronic device of claim 4, wherein detecting whether the electronic device is in the stationary state includes at least one of:
detecting whether an acceleration of the electronic device along a first axis is within a first threshold;
detecting whether the acceleration of the electronic device along a second axis is within a second threshold; and
detecting whether the acceleration of the electronic device along a third axis is within a third threshold.

6. The electronic device of claim 1, wherein the movement is performed based on an indication of at least one of an x-axis acceleration, y-axis acceleration, and z-axis acceleration that is provided by the accelerometer.

7. The electronic device of claim 1, wherein the operation is performed when at least one of an x-axis acceleration, y-axis acceleration, and z-axis acceleration of the electronic device meets a threshold.

8. The electronic device of claim 7, wherein the electronic device remains in a live preview state when the at least one of the x-axis acceleration, y-axis acceleration, and z-axis acceleration fails to meet the threshold.

9. The electronic device of claim 1, wherein the operation is detected after a preset period following the movement of the electronic device.

10. The electronic device of claim 1, wherein the operation is performed when no other movement of the electronic device is detected for a preset period following the movement of the electronic device.

11. A method for use in an electronic device, comprising:
detecting a movement of the electronic device by using an accelerometer; and
performing an operation associated with at least one camera based on the movement.

12. The method of claim 11, further comprising transitioning the electronic device into a camera standby mode in response to a predetermined command.

13. The method of claim 11, wherein the movement of the electronic device is caused by at least one of an impact, a tap, and a shake of the electronic device.

14. The method of claim 11, further comprising detecting whether the electronic device is in a stationary state, wherein the movement of the electronic device is detected after detecting that the electronic device is in the stationary state.

15. The method of claim 14, wherein detecting whether the electronic device is in the stationary state includes at least one of:
detecting whether an acceleration of the electronic device along a first axis is within a first threshold;
detecting whether the acceleration of the electronic device along a second axis is within a second threshold; and
detecting whether the acceleration of the electronic device along a third axis is within a third threshold.

16. The method of claim 11, wherein the movement is performed based on an indication of at least one of an x-axis acceleration, y-axis acceleration, and z-axis acceleration that is provided by the accelerometer.

17. The method of claim 11, wherein the operation is performed when at least one of an x-axis acceleration, y-axis acceleration, and z-axis acceleration of the electronic device meets a threshold.

18. The method of claim 17, wherein the electronic device remains in a live preview state when the at least one of the x-axis acceleration, y-axis acceleration, and z-axis acceleration fails to meet the threshold.

19. The method of claim 11, wherein the operation is detected after a preset period following the movement of the electronic device.

20. A non-transitory computer-readable medium storing one or more processor-executable instructions, which when executed by an electronic device cause the electronic device to perform a method comprising the steps of:
detecting a movement of the electronic device by using an accelerometer; and
performing an operation associated with at least one camera based on the movement.
